(19) United States
(12) Patent Application Publication
(10) Pub. No.: US 2020/0377760 A1
(43) Pub. Date: Dec. 3, 2020

(54) FLOOR COATING MATERIAL, METHOD FOR COATING FLOOR, AND METHOD FOR PRODUCING FLOOR STRUCTURE

(71) Applicant: YUSHIRO CHEMICAL INDUSTRY CO., LTD., Ota-Ku (JP)

(72) Inventors: Fumi HASEGAWA, Koza-Gun (JP); Kazuyuki WATANABE, Koza-Gun (JP); Masao HIWATARI, Koza-Gun (JP); Aya NICHOGI, Koza-Gun (JP)

(73) Assignee: YUSHIRO CHEMICAL INDUSTRY CO., LTD., Ota-Ku (JP)

(21) Appl. No.: 16/603,393

(22) PCT Filed: Apr. 9, 2018
(86) PCT No.: PCT/JP2018/014960

§ 371 Date: Oct. 7, 2019

(30) Foreign Application Priority Data
Apr. 12, 2017 (JP) 2017-079229

(51) Int. Cl. C09D 183/14; E04F 15/12; C09D 7/47; C09D 7/61; C09D 7/63

(52) U.S. Cl. CPC C09D 183/14; E04F 15/12; C08K 2003/329; C09D 7/61; C09D 7/63; C09D 7/47

(57) ABSTRACT

A floor coating material including one or both of a silane coupling agent and an alkoxysilane, as a first component; one or both of silica and a metal oxide, as a second component; a leveling agent as a third component; a curing catalyst as a fourth component; and water as a fifth component; wherein a content of the first component is 5 mass % or more and 70 mass % or less, a content of the second component is 1 mass % or more and 50 mass % or less, a content of the third component is 0.001 mass % or more and 1 mass % or less, a content of the fourth component is 0 mass % or more and 7 mass % or less, and a content of the fifth component is a balance, all based on the total mass of the first to fifth components.

### TECHNICAL FIELD

The present invention relates to a floor coating material, a method for coating a floor, and a method for producing a floor structure.

### BACKGROUND ART

Conventionally, for the purposes of aesthetic appearance maintenance and stain-resistance of a floor, a coating material is applied to the surface thereof, and various coating materials therefor have been developed (see, for example, patent literature 1 and patent literature 2).

However, most of coating materials that come onto the market, including the coating materials disclosed in Patent Literature 1 and Patent Literature 2, are so-called solvent-based coating materials, in which a volatile organic solvent such as an alcohol is used as a medium. These solvent-based coating materials are excellent in gloss and durability, but there is a risk that workers inhale the volatilizing medium while at work to thereby lose their health. This can be prevented to a certain extent by air ventilation during work, but it is not a radical solution.

On the other hand, so-called water-based coating materials, in which water is used as a medium, have also been developed recently (for example, Patent Literature 3). Water-based coating materials are unlike the solvent-based coating materials. Specifically, although there is a small health risk even when workers inhale a volatilizing medium therefrom while at work, many water-based coating materials have insufficient gloss and durability compared to solvent-based coating materials, and thus, there is a room for improvement in water-based coating materials.

### CITATION LIST

### Patent Literature

Patent Literature 1: Japanese Patent Laid-Open Publication No. 2011-236706
Patent Literature 2: Japanese Patent No. 4957926
Patent Literature 3: Japanese Patent Laid-Open Publication No. H10-251599

### SUMMARY OF INVENTION

### Technical Problem

The present invention has been made under these circumstances, and a main object thereof is to provide a floor coating material that enables use under high safe environment and is excellent in gloss and durability, a method for coating a floor, and a method for producing a floor structure.

### Solution to Problem

A present invention for achieving the object above directs to a floor coating material comprising: one or both of a silane coupling agent and an alkoxysilane, as a first component; one or both of silica and a metal oxide, as a second component; a leveling agent as a third component; a curing catalyst as a fourth component; and water as a fifth component; wherein a content of the first component is 5 mass % or more and 70 mass % or less, a content of the second component is 1 mass % or more and 50 mass % or less, a content of the third component is 0.001 mass % or more and 1 mass % or less, a content of the fourth component is 0 mass % or more and 7 mass % or less, and a content of the fifth component is a balance, all based on the total mass of the first to fifth components, and a total mass content of the first to fifth components is 95 mass % or more and 100 mass % or less based on the total mass of the floor coating material.

In the invention above, it is preferable that the first component comprise one or more selected from a silane coupling agent having an epoxy group, a silane coupling agent having an amino group, and an alkoxysilane oligomer, and also that a total content of the first component, the third component and components other than the first to fifth components be less than 40 mass % based on the total mass of the floor coating material.

In the invention above, it is preferable that the silane coupling agent as the first component be a silane coupling agent having an epoxy group, and also that the curing catalyst as the fourth component is phosphoric acid.

In the invention above, the silane coupling agent as the first component may include a silane coupling agent having an amino group while the floor coating material does not include the curing catalyst as the fourth component.

Another invention for achieving the object above directs to a method for coating a floor, comprising a coating material-applying step of applying a floor coating material to a surface to be coated, wherein the floor coating material used in the coating material-applying step is the floor coating material of the present invention described above.

Yet another invention for achieving the object above directs to a method for producing a floor structure, comprising a coating material-applying step of applying a floor coating material to a surface to be coated, wherein the floor coating material used in the coating material-applying step is the floor coating material of the present invention described above.

### Advantageous Effect of Invention

The floor coating material of the present invention is unlike so-called solvent-based coating materials, and specifically, enables use under high safe environment since water is used as a medium therein. The floor coating material of the present invention is also excellent in gloss and durability compared to conventional water-based coating materials since the first to fourth components are included therein in the respective specific amounts.

The method for coating a floor and the method for producing a floor structure of the present invention also exhibit the same effects as above since the floor coating material of the present invention is used therein.

### DESCRIPTION OF EMBODIMENTS

The present invention will be described in detail below.

### I. Floor Coating Material

The floor coating material according to an embodiment of the present invention comprises: one or both of a silane coupling agent and an alkoxysilane, as a first component; one or both of silica and a metal oxide, as a second component; one or both of a silicone compound and a fluorosurfactant, as a third component; a curing catalyst as a fourth component (the fourth component may not be included); and water as a fifth component; wherein a content of the first component is 5 mass % or more and 70 mass % or less, a content of the second component is 1 mass % or more and 50 mass % or less, a content of the third component is 0.001 mass % or more and 1 mass % or less, a content of the fourth component is 0 mass % or more and 7 mass % or less, and a content of the fifth component is a balance, all based on the total mass of the first to fifth components, and a total mass content of the first to fifth components is 95 mass % or more and 100 mass % or less based on the total mass of the floor coating material.

### (1) First Component

The first component composing the floor coating material according to the present embodiment is one or both of a silane coupling agent and an alkoxysilane.

As is known, the “silane coupling agent” herein is a silicon compound having in the molecule thereof two kinds of functional groups different in reactivity, which are specifically a hydrolyzable group (X) having affinity for and reactivity with inorganic materials and an organic functional group (Y) chemically bondable to organic materials. The structure thereof is not particularly limited and can be generally represented by the general formula (I) below.

X₃₋ₙMeₙSi—R—Y (I)

wherein X is a hydrolyzable group, Y is an organic functional group, Me is a methyl group, R is an alkylene group having 2 to 3 carbon atoms, and n is 0 or 1.

Examples of the hydrolyzable group (X) generally include, but not particularly limited to, CH₃—O— (methoxy), CH₃CH₂—O— (ethoxy), and CH₃OCH₂CH₂—O— (2-methoxyethoxy). Examples of the alkylene group (R) generally include, but not particularly limited to, an ethylene group and a propylene group.

Examples of the organic functional group (Y) generally include various groups such as —NH₂ (amino), —CH═CH₂ (vinyl), —OOC(CH₃)C═CH₂ (methacryl), —N═C═O (isocyanate), —SH (mercapto), —S— (sulfur), —NHCONH₂ (ureide), —OCH₂CHOCH₂ (glycidoxy), and an epoxy group. Silane coupling agents having an amino group or an epoxy group among these are preferable, and those having an epoxy group are more preferable.

Specific examples of the silane coupling agent having an epoxy group include 3-glycidoxypropyltrimethoxysilane, 3-glycidoxypropylmethyldimethoxysilane, 3-glycidoxypropylmethyldiethoxysilane, 2-(3,4-epoxycyclohexyl)ethyltrimethoxysilane, 3-glycidoxypropyltriethoxysilane, and 3-glycidoxypropylmethyldiisopropenoxysilane. Specific examples of the silane coupling agent having an amino group include 3-aminopropyltriethoxysilane, 3-aminopropyltrimethoxysilane, N-2-(aminoethyl)-3-aminopropylmethyldimethoxysilane, and N-2-(aminoethyl)-3-aminopropyltrimethoxysilane.

The alkoxysilane as the first component is not particularly limited and examples thereof include an alkoxysilane represented by the general formula (II) below.

R²ₙSi(OR¹)₄₋ₙ (II)

wherein R¹ and R² are each an alkyl group having 1 to 20 carbon atoms, and n represents an integer of 0 to 3.

Specific examples of the alkoxysilane represented by the general formula (II) include methyltrimethoxysilane, methyltriethoxysilane, methyltriisopropoxysilane, methyltributoxysilane, ethyltrimethoxysilane, propyltrimethoxysilane, hexyltrimethoxysilane, phenyltrimethoxysilane, decyltrimethoxysilane, dimethyldimethoxysilane, dimethyldiethoxysilane, dimethyldibutoxysilane, methylphenyldimethoxysilane, diphenyldimethoxysilane, tetramethoxysilane, tetraethoxysilane and tetrabutoxysilane.

When tetramethoxysilane, tetraethoxysilane, tetrapropoxysilane, or the like is used among these, a coating film to be obtained has excellent hardness.

The silane coupling agents and the alkoxysilanes described above may be used singly or in combinations of two or more thereof. Many of the alkoxysilanes have a low boiling point to thereby easily volatilize and also have odor or toxicity, and therefore, an oligomer (having a polymerization degree of about 2 to 20, for example) of the alkoxysilane may be synthesized before use. By using oligomers having various molecular weights in combination, the hardness of a coating film to be obtained can be controlled. By using alkoxysilanes different in the size of the substituent, e.g., methyltrimethoxysilane and phenyltrimethoxysilane, in combination, the balance between hydrophilicity and hydrophobicity as well as the crosslinking speed can be controlled. By using a silane coupling agent having an epoxy group and an alkoxysilane in combination, the adhesion of the floor coating material according to the present embodiment to the substrate to be coated therewith (the surface of a floor, or an undercoating layer) can be improved.

Such a first component is contained in an amount of 5 mass % or more and 70 mass % or less, preferably 5 mass % or more and 50 mass % or less, more preferably 10 mass % or more and 50 mass % or less, based on the total mass of the first component to the fifth components described later. If the content of the first component is less than 5 mass %, a continuous film cannot be formed or may have an insufficient film strength, if formed. On the other hand, if the content of the first component is more than 70 mass %, a film to be obtained cannot withstand the volumetric shrinkage caused in the inner part of the film when curing, which leads to a risk of causing a crack in the film.

### (2) Second Component

The second component composing the floor coating material according to the present embodiment is one or both of silica and a metal oxide.

The silica is not particularly limited, and for example, colloidal silica having an average particle size of 5 to 50 nm may be used. When using silica having such a small particle size, the gap between silica particles are filled with the silane coupling agent or the alkoxysilane as the first component or the like, and thus the resulting coating film is allowed to have large hardness. The gloss of a coating film formed on a floor is reduced by impact due to walk as well as the occurrence of scratches due to wear by sand. The main component of sand is silicates and therefore, by incorporating silica, which has similar hardness to silicates, the occurrence of scratches can be prevented to maintain an original high gloss. Therefore, when silica is used in a large amount to allow the coating film to have large hardness, the maintenance performance on gloss can be enhanced.

Alternatively to or in addition to silica, a metal oxide can be used for the same purpose as that of silica. The metal oxide is also not particularly limited and examples thereof include oxides such as alumina, magnesium oxide, zinc oxide, titanium oxide, red iron oxide, chromium oxide, iron black (iron oxide), zirconium oxide and tin oxide; and composite oxides such as titanium-cobalt green, cobalt green (pigment containing cobalt oxide and zinc oxide), cobalt blue (pigment containing cobalt aluminate), copper-chromium black, copper-iron black, titanium yellow, and zinc-iron brown. These may be used singly or in combinations of two or more thereof. The form of these is not limited, and, for example, the metal oxide may be dispersed in water in advance to give an aqueous dispersion before use.

Such a second component is contained in an amount of 1 mass % or more and 50 mass % or less, preferably 5 mass % or more and 40 mass % or less, more preferably 5 mass % or more and 30 mass % or less, based on the total mass of the second component, the first component, and the third to fifth components described later. If the content of the second component is less than 1 mass %, the effects may not be expected. If the content is more than 50 mass %, the contents of other components are accordingly small to lose the balance; thus there are risks, for example, that gelation may be caused to fail to prepare a floor coating material, or that a coating film to be obtained lacks transparency to result in poor appearance.

### (3) Third Component

The third component composing the floor coating material according to the present embodiment is one or both of a silicone compounds and a fluorosurfactant.

The silicone compound and the fluorosurfactant function as so-called a leveling agent. By incorporating any of these, the surface tension of the floor coating material according to the present embodiment can be reduced. Thus, the film surface can smooth down, and concomitantly high gloss and sufficient durability can be imparted thereto. Also, the silicone compound and the fluorosurfactant are both preferable in view of excellent compatibility and also promoting self-smoothing.

Specific examples of the silicone compound include a silicone oil, a silicone resin emulsion, an amino-modified silicone, a polyether-modified silicone, a silicone rubber emulsion, an ethylenically unsaturated monomer-modified silicone, an ethylenically unsaturated polymer-modified silicone, and a silicone surfactant.

The fluorosurfactant is a surfactant having an alkyl chain in which a hydrogen atom has been replaced with a fluorine atom. Specific examples thereof include a perfluoroalkyl carboxylic acid, a perfluoroalkyl ammonium salt, a perfluoroalkyl compound, a perfluoroalkylamine oxide, a perfluoroalkyl ethylene oxide, a perfluoroalkyl-containing polymer, a perfluoroalkyl amino acid salt, a perfluoroalkyl sulfonic acid, a perfluoroalkyl carboxylic acid, and a fluoro telomer alcohol.

These silicone compounds and fluorosurfactants may be used singly or in combinations of two or more thereof.

Such a third component is contained in an amount of 0.001 mass % or more and 1 mass % or less, preferably 0.005 mass % or more and 1 mass % or less, more preferably 0.01 mass % or more and 1 mass % or less, based on the total mass of the third component, the first to second components, and the fourth to fifth components described later. If the content of the third component is less than 0.001 mass %, repellence or the like may be caused due to the difference in the surface tension between the surface to be coated and the floor coating material when the floor coating material according to the present embodiment is applied. If the content of the third component is more than 1 mass %, foaming, bleeding, bleaching, and tackiness derived from the third component may be caused on the surface of the film to result in poor appearance.

When the silicone compound is used as the third component, the content thereof is particularly preferably 0.01 mass % or more and 1 mass % or less. When the fluorosurfactant is used as the third component, the content thereof is particularly preferably 0.001 mass % or more and 0.1 mass % or less.

### (4) Fourth Component

The fourth component composing the floor coating material according to the present embodiment is a curing catalyst.

The curing catalyst is not particularly limited and examples thereof include inorganic acids such as hydrochloric acid, nitric acid, sulfuric acid, and phosphoric acid; organic acids such as formic acid, acetic acid, propionic acid, p-toluenesulfonic acid, benzoic acid, phthalic acid and maleic acid; alkaline catalysts such as potassium hydroxide, sodium hydroxide, calcium hydroxide and ammonia; metal alkoxides; organotin compounds such as dibutyltin laurate, dibutyltin dioctyate, and dibutyltin diacetate; metal chelate compounds such as aluminum tris(acetylacetonate), titanium tetrakis(acetylacetonate), titanium bis(butoxy)bis(acetylacetonate), titanium bis (isopropoxy)bis(acetylacetonate), zirconium tetrakis(acetylacetonate), zirconium (butoxy)bis(acetylacetonate), and zirconium (isopropoxy)bis(acetylacetonate); and boron compounds such as boron butoxides and boric acid.

Among these, phosphoric acid is particularly preferred as a curing catalyst for the case where a silane coupling agent having an epoxy group is used as the first component above described. Phosphoric acid is soluble in water and the resulting solution is acidic. When using phosphoric acid, the reaction speed of the condensation reaction of the silane coupling agent having an epoxy group is not too fast and is adequate, and viscosity increase can thus be moderate to secure excellent spreadability. Phosphoric acid is preferred also in view of sufficiently promoting curing of the coating material applied.

Such a fourth component is contained in an amount of 0 mass % or more and 7 mass % or less, preferably 0.15 mass % or more and 5 mass % or less, more preferably 0.3 mass % or more and 5 mass % or less, based on the total mass of the fourth component, the first to third components, and the fifth component described later. If the content of the fourth component is more than 7 mass %, the condensation may proceed excessively to thereby fail to obtain sufficient film strength, and also the floor coating material according to the present embodiment may have a high viscosity to impair the spreadability and finish appearance. On the other hand, the fourth component is not a necessary component, and the lower limit of the content thereof is 0 mass %. Generally, when the content of the fourth component is less than 0.15 mass %, the condensation reaction may usually proceed slowly to lead a risk of insufficient curing of the coating film, since the fourth component is a catalyst. However, when a silane coupling agent having an amino group is included in the first component, the silane coupling agent having an amino group performs a so-called catalyst function, and as a result, it is not necessary in some cases that any catalyst such as phosphoric acid be contained as the fourth component. When any catalyst is not contained as the fourth component, pre-treatment that is necessary due to containing a catalyst (e.g., phosphoric acid) is unnecessary, and therefore reduction in operation time is expected.

When a silane coupling agent having an epoxy group is used as the first component, the ratio between the silane coupling agent and the fourth component is generally 30:1 to 10:1 (mass ratio).

### (5) Fifth Component

The fifth component composing the floor coating material according to the present embodiment is water.

Water is a necessary component for hydrolysis of the first component, and is also an important component for adjusting the viscosity of the floor coating material according to the present embodiment. In order to prevent the occurrence of a crack in and a warp of the coating film to be obtained by applying the floor coating material, control of the thickness of the coating film is needed, and for controlling the thickness of the coating film, water as the fifth component functions as a so-called diluent medium.

The content of such water is the remainder, i.e., the balance obtained by subtracting the total mass of the first to fourth components from that of the first to fifth components.

Since the floor coating material according to the present embodiment contains a silicone compound and a fluorosurfactant as the third component, which function as a so-called leveling agent, and water as a fifth component, which functions as a diluent medium to adjust the viscosity, in a specific ratio, the floor coating material is allowed to be a so-called water-based system, which contains no organic solvent. Thus, a probability that workers inhale organic solvents while at work of coating is significantly reduced, and therefore characteristics such as improvements of working environment and safety, reduction in odors, and resource-saving are given.

Generally, since water has a high surface tension, water becomes water drops to thereby fail to spread wetly when applied. However, since the floor coating material according to the present embodiment contains a silicone compound and a fluorosurfactant as a third component, which function as a so-called leveling agent, to adjust the surface tension, a smooth film can be formed and the film concomitantly has high gloss and sufficient durability.

### (6) Other Components

In the floor coating material according to the present embodiment, the total mass content of the first to fifth components is 95 mass % or more and 100 mass % or less based on the total mass of the floor coating material. In other words, it can be acceptable to contain other components than the first to fifth components in a proportion less than 5 mass %.

The other components than the first to fifth components are not particularly limited and an antifoaming agent, an antistatic agent, a perfume, a leveling aid for making up for the function of the third component as a leveling agent described above, and others can be added as needed.

Examples of the leveling aid include fatty acid esters, fatty acid alkanolamides as well as a sulfosuccinate ester salt, an anionic surfactant, a nonionic surfactant, an amphoteric surfactant, a polyoxyethylene alkyl ether, a polyoxyethylene polyoxypropylene alkyl ether, a polyoxyethylene polyoxypropylene copolymer, an acrylic copolymer, and tributoxyethyl phosphate.

Specific examples of the fatty acid ester as the leveling aid include a sucrose fatty acid ester, a sorbitan fatty acid ester, a polyethylene glycol fatty acid ester, an aliphatic monocarboxylic acid ester of a dihydric alcohol, a monofatty acid ester of a polyoxyethylene alkyl ether, and a polyglycerol fatty acid ester.

Specific examples of the fatty acid alkanolamide as the leveling aid include coconut oil fatty acid diethanolamide, lauric acid diethanolamide, lauric acid/myristic acid diethanolamide, myristic acid diethanolamide, oleic acid diethanolamide, and palm kernel oil fatty acid diethanolamide.

### (7) Content of Combustible Liquid

In the floor coating material according to the present embodiment, it is preferable that the first component be one or more selected from a silane coupling agent having an epoxy group, a silane coupling agent having an amino group, and an alkoxysilane oligomer, and also that a total content of the first component, the third component and the other components (components other than the first to fifth components) be less than 40 mass % based on the total mass of the floor coating material.

An article that is a liquid having a flash point of 40° C. or higher and lower than 70° C. at 1 atom, contains 40 mass % or less of a combustible liquid, and has a burning point of 60° C. or higher falls within designated combustibles and does not fall within hazardous materials according to Fire Service Act. Herein, a “flash point” is measured according to the rapid equilibrium closed cup method defined in JIS K 2265-2, and “designated combustibles” are defined as follows in Fire Service Act, article 9-4: straw products, woody-wool, and others designated by Cabinet Order as articles which will, once having caught fire, lead to the quick spread of the fire or make it extremely difficult to carry out fire extinguishing activities. When handling hazardous materials defined by Fire Service Act, the hazardous materials engineer's license is needed.

Among the components composing the floor coating material according to the present embodiment, the first component, the third component, and some other components fall within combustible liquids. Under the condition that the first component is one or more selected from a silane coupling agent having an epoxy group, a silane coupling agent having an amino group, and an alkoxysilane oligomer, and also the condition that the total content of the first component, the third component and the other components (components other than the first to fifth components) is less than 40 mass % based on the total mass of the floor coating material, the floor coating material according to the present embodiment falls within the designated combustibles and does not fall within hazardous materials according to Fire Service Act, and therefore the hazardous materials engineer's license is not needed, which is preferable.

### (8) Viscosity

The viscosity (25° C.) of the floor coating material according to the present embodiment is not particularly limited, and preferably 2 mPa·s or more and 50 mPa·s or less, and particularly preferably 2 mPa·s or more and 10 mPa·s or less. The “viscosity” herein is measured with a viscometer specified in JIS K 7117-1, JIS K 7117-2, and JIS Z 8803, and it represents the property of resisting to a flow generated inside a liquid, and refers to a ratio between the shear stress and the shear rate. The viscosity within the range described above is advantageous to carrying out coating work with a roller, a mop, or the like, and also secures the self-leveling property, so that a smooth coating film can be formed. The viscosity of the floor coating material according to the present embodiment can be set within the range described above by appropriately adjusting the contents of the components described above, particularly the content of water as the fifth component.

### (9) Solid Content

The solid content of the floor coating material according to the present embodiment is preferably 10 mass % or more, particularly preferably 30 mass % or more, based on the total mass of the floor coating material. The solid content within the range described above allows a coating film to be obtained from the floor coating material according to the present embodiment to have favorable gloss. Among the components composing the floor coating material according to the present embodiment, the first component, the second component, and also some other components correspond to the solid content, and therefore the solid content can be set within the range described above by appropriately adjusting the contents of these.

### II. Method for Coating Floor and Method for Producing Floor Structure

The method for coating a floor and the method for producing a floor structure according to the embodiment of the present invention are each characterized by comprising a coating material-applying step of applying the floor coating material according to the present embodiment described above to a surface to be coated.

In the coating material-applying step, the specific means for applying the floor coating material according to the present embodiment is not particularly limited, and conventionally known various application means can be selected appropriately. Examples thereof include the application with a brush or a roller, the application with a spray, and the application with a mop, a sponge, or waste cloth for applying wax.

In the coating material-applying step, the amount applied of the floor coating material according to the present embodiment is not particularly limited, and can appropriately be set according to the desired gloss and durability. For example, the amount applied can be set such that the coating film to be obtained according to the method for coating a floor or the method for producing a floor structure according to the present embodiment has a dry thickness of 2 μm or more and 100 μm or less. When the thickness of the coating film is within the range described above, the favorable gloss can be maintained while the durability can also be secured.

In the method for coating a floor and the method for producing a floor structure according to the present embodiment, the coating material applied is dried after the coating material-applying step is carried out in the above-described manner. The method for drying is not particularly limited and drying may be carried out according to a usual method. For example, the coating material applied may be air-dried at room temperature for 1 hour or more.

In the method for coating a floor and the method for producing a floor structure according to the present embodiment, the surface to be coated on which the coating material-applying step is carried out is not particularly limited. The coating material-applying step may be carried out directly on various flooring materials, or an undercoating treatment may be carried out, including forming an undercoating layer on the surface to be coated.

Examples of the flooring material as the surface to be coated include a plastic flooring material (specifically including a vinyl flooring material, a rubber flooring material, a olefin flooring material, and a coated flooring material), a stone flooring material (specifically including marble, granite, terrazzo, a pottery flooring material, and ceramic), and a woody flooring material (specifically including a wooden flooring material, and a cork tile). The method for coating a floor and the method for producing a floor structure according to the present embodiment are particularly effective for a vinyl flooring material among these.

When the surface to be coated is an undercoating layer, the undercoating layer may be, for example, an undercoating layer formed by applying and drying an undercoating material containing 10 to 50 mass % of at least one resin selected from an acrylic resin, a urethane resin, and an acrylic urethane and 0.5 to 30 mass % of at least one crosslinking agent selected from an isocyanate compound, an oxazoline compound, a compound having a carbodiimide group, an epoxy compound, and a polyvalent metal compound.

Since the undercoating material contains 10 to 50 mass % of the resin and 0.5 to 30 mass % of the crosslinking agent, the resin and the crosslinking agent are contained in a mass ratio of 10 to 50:0.5 to 30. In addition to 10 to 50 mass % of the resin and 0.5 to 30 mass % of the crosslinking agent, the undercoating material contains 20 to 89.5 mass % of other components based on 100 mass % of the total of the undercoating material.

Specific examples of the resin include a reaction product between an acrylic polyol and an isocyanate compound, and a composite obtained by crosslinking an acrylic resin having a functional group and a urethane resin having a functional group.

As the crosslinking agent, an isocyanate compound, an oxazoline compound, a compound having a carbodiimide group, an epoxy compound, and a polyvalent metal compound can be used singly or in combinations of two or more thereof. Among these, a compound having a carbodiimide group is more preferable. Specific examples of the compound having a carbodiimide group include dicyclohexylcarbodiimide, dicyclohexylmethanecarbodiimide, tetramethyl xylylene carbodiimide, and 1-ethyl-3-(3-dimethylaminopropyl)carbodiimide hydrochloride. As the resin and the crosslinking agent, respective known products and commercially available products can be used.

Typical examples of the other components include water, a film-forming aid, and a leveling agent. The basecoat undercoating material may contain, for example, a plasticizer, an antifoaming agent, and colloidal silica as long as the effect of the present invention is not impaired.

The thickness of the undercoating layer formed from such an undercoating material is not particularly limited, and may be, for example, about 10 μm or more and about 50 μm or less.

When the flooring material to be coated is a vinyl flooring material, it is preferable to form an undercoating layer from the undercoating material described above because the reaction of the floor coating material according to an embodiment of the present invention can be promoted while providing improved adhesion.

### EXAMPLES

### Example 1

### (1) Preparation of Floor Coating Material

Mixed were 30 mass % of a silane coupling agent (KBM 403, manufactured by Shin-Etsu Chemical Co., Ltd.) as the first component, 2.5 mass % of colloidal silica (40 mass % aqueous dispersion of silica (average particle size: 20 to 25 nm), manufactured by Nissan Chemical Corporation) (accordingly, the amount of silica was 1 mass %) as the second component, 0.005 mass % of a fluorosurfactant (Surflon S-211, manufactured by AGC SEIMI CHEMICAL CO., LTD.) as the third component, 1.5 mass % of phosphoric acid as the fourth component, and 67.495 mass % of water (including water contained in the colloidal silica) as the fifth component, to thereby prepare a floor coating material according to Example 1. The formulation thereof is shown in Table 1.

For the floor coating material according to Example 1, the total amount of the combustible products (total amount of designated combustibles defined in Fire Service Act, article 9-4) in the floor coating material, the solid content, the flash point (according to the rapid equilibrium closed cup method defined in JIS K 2265-2), and the burning point (according to JIS K 2265-4) were each calculated. These results are shown in Table 1.

### (2) Application to Flooring Material

An undercoating material was applied to the surface of a homogeneous vinyl tile as a flooring material, the undercoating material consisting of 50 mass % of a urethane resin emulsion (NeoRez R-960, manufactured by Kusumoto Chemicals, Ltd.), 5 mass % of a crosslinking agent (CARBODILITE, manufactured by Nisshinbo Chemical Inc.), 5 mass % of a film-forming aid (diethylene glycol monoethyl ether, manufactured by The Dow Chemical Company), 0.01 mass % of a leveling agent (Surflon S-211, manufactured by AGC SEIMI CHEMICAL CO., LTD.) and 39.99 mass % of water, and the resultant was left at a room temperature for 1 hours to form an undercoating layer. Then the floor coating material according to Example 1 was applied to the undercoating layer and left a room temperature for 24 hours to form a coating film.

### (3) Evaluations of Coating Film

The gloss of the coating film was measured (according to JIS K3920-15), and also the adhesion (according to JIS K5600-5-6), the wear resistance, and the appearance thereof were evaluated according to the following scales. For the wear resistance, the coating film was worn using a 14-inch polisher with Scotch-Brite black stripping pad (black) at 30 sec/m², and the wear resistance of the film was evaluated on the basis of the gloss after wearing. The evaluation of the appearance was carried out on the basis of the result of the gloss. The results are shown in Table 1.

Evaluation Scale for Adhesion

Class 0: The edge of the cut is completely smooth, and any square of the grid is not peeled off.
Class 1: Small peeling of the coating is found at the intersection of the cuts.
Class 2: The coating is peeled along the edge of the cut and/or at the intersection of the cuts.
Class 3: Large peeling of the coating is found along the edge of the cut partly or over all, and/or a plurality of squares are peeled partly or over all.

Evaluation Scale for Wear Resistance

A: having a gloss of 80% or more
B: having a gloss of 70% or more and less than 80%
C: having a gloss of 60% or more and less than 70%
D: having a gloss of less than 60%

Evaluation Scale for Appearance

A: having a gloss of 80% or more without any crack
B: having a gloss of 70% or more and less than 80% without any crack
C: having a gloss of less than 70% without any crack
D: a crack or bleed occurs.

### (4) Evaluation for Leveling Property

The leveling property was evaluated on the coating film (according to JIS K3920-21). Specifically, a coating material was evenly applied on a substrate, and just after the application, a letter “X” was written along the diagonal lines of the substrate with the used application tool. After drying, it was determined through visual observation to what extent the letter “X” had disappeared. When the letter “X” was clearly found, a rating D was given; when the letter “X” was slightly found, a rating C was given; when the outline of the letter “X” was slightly found with some variations of gloss, a rating B was given; and when the letter “X” was not found, a rating A was given. The evaluation results of the leveling property are shown in Table 1.

### Example 2

### (1) Preparation of Floor Coating Material

A floor coating material according to Example 2 was prepared in the same manner as in Example 1, except the following: 10 mass % of an alkoxysilane and 20 mass % of a silane coupling agent (KBM 403, manufactured by Shin-Etsu Chemical Co., Ltd.) were used as the first component; 50 mass % of colloidal silica (40 mass % aqueous dispersion of silica (average particle size: 20 to 25 nm), manufactured by Nissan Chemical Corporation) (accordingly, the amount of silica was 20 mass %) was used as the second component; and 48.495 mass % of water (including water contained in the colloidal silica) was used as the fifth component. The formulation thereof is shown in Table 1.

For the floor coating material according to Example 2, the total amount of the combustible products, the solid content, the flash point, and the burning point were each calculated in the same manner as in Example 1. These results are shown in Table 1.

### (2) Application to Flooring Material

A coating film was formed in the same manner as in Example 1, except that the floor coating material according to Example 2 was used.

### (3) Evaluations of Coating Film

The gloss, the adhesion, the wear resistance, and the appearance of the coating film obtained were evaluated in the same manner as in Example 1. These results are shown in Table 1.

### (4) Evaluation for Leveling Property

The leveling property of the coating film obtained was evaluated in the same manner as in Example 1. The result is shown in Table 1.

### Example 3

### (1) Preparation of Floor Coating Material

A floor coating material according to Example 3 was prepared in the same manner as in Example 1, except the following: 30 mass % of colloidal silica (40 mass % aqueous dispersion of silica (average particle size: 20 to 25 nm), manufactured by Nissan Chemical Corporation) (accordingly, the amount of silica was 12 mass %) was used as the second component; 0.5 mass % of phosphoric acid was used as the fourth component; and 57.495 mass % of water (including water contained in the colloidal silica) was used as the fifth component. The formulation thereof is shown in Table 1.

For the floor coating material according to Example 3, the total amount of the combustible products, the solid content, the flash point, and the burning point were each calculated in the same manner as in Example 1. These results are shown in Table 1.

### (2) Application to Flooring Material

A coating film was formed in the same manner as in Example 1, except that the floor coating material according to Example 3 was used.

### (3) Evaluations of Coating Film

The gloss, the adhesion, the wear resistance, and the appearance of the coating film obtained were evaluated in the same manner as in Example 1. These results are shown in Table 1.

### (4) Evaluation for Leveling Property

The leveling property of the coating film obtained was evaluated in the same manner as in Example 1. The result is shown in Table 1.

### Example 4

### (1) Preparation of Floor Coating Material

A floor coating material according to Example 4 was prepared in the same manner as in Example 1, except the following: 10 mass % of a silane coupling agent (KBM 403, manufactured by Shin-Etsu Chemical Co., Ltd.) was used as the first component; 30 mass % of colloidal silica (40 mass % aqueous dispersion of silica (average particle size: 20 to 25 nm), manufactured by Nissan Chemical Corporation) (accordingly, the amount of silica was 12 mass %) was used as the second component; and 76.495 mass % of water (including water contained in the colloidal silica) was used as the fifth component. The formulation thereof is shown in Table 1.

For the floor coating material according to Example 4, the total amount of the combustible products, the solid content, the flash point, and the burning point were each calculated in the same manner as in Example 1. These results are shown in Table 1.

### (2) Application to Flooring Material

A coating film was formed in the same manner as in Example 1, except that the floor coating material according to Example 4 was used.

### (3) Evaluations of Coating Film

The gloss, the adhesion, the wear resistance, and the appearance of the coating film obtained were evaluated in the same manner as in Example 1. These results are shown in Table 1.

### (4) Evaluation for Leveling Property

The leveling property of the coating film obtained was evaluated in the same manner as in Example 1. The result is shown in Table 1.

### Example 5

### (1) Preparation of Floor Coating Material

A floor coating material according to Example 5 was prepared in the same manner as in Example 4, except the following: 30 mass % of a silane coupling agent (KBM 403, manufactured by Shin-Etsu Chemical Co., Ltd.) was used as the first component; and 56.495 mass % of water (including water contained in the colloidal silica) was used as the fifth component. The formulation thereof is shown in Table 1.

For the floor coating material according to Example 5, the total amount of the combustible products, the solid content, the flash point, and the burning point were each calculated in the same manner as in Example 1. These results are shown in Table 1.

### (2) Application to Flooring Material

A coating film was formed in the same manner as in Example 1, except that the floor coating material according to Example 5 was used.

### (3) Evaluations of Coating Film

The gloss, the adhesion, the wear resistance, and the appearance of the coating film obtained were evaluated in the same manner as in Example 1. These results are shown in Table 1.

### (4) Evaluation for Leveling Property

The leveling property of the coating film obtained was evaluated in the same manner as in Example 1. The result is shown in Table 1.

### Example 6

### (1) Preparation of Floor Coating Material

A floor coating material according to Example 6 was prepared in the same manner as in Example 4, except the following: 39 mass % of a silane coupling agent (KBM 403, manufactured by Shin-Etsu Chemical Co., Ltd.) was used as the first component; and 47.495 mass % of water (including water contained in the colloidal silica) was used as the fifth component. The formulation is shown in Table 1.

For the floor coating material according to Example 6, the total amount of the combustible products, the solid content, the flash point, and the burning point were each calculated in the same manner as in Example 1. These results are shown in Table 1.

### (2) Application to Flooring Material

A coating film was formed in the same manner as in Example 1, except that the floor coating material according to Example 6 was used.

### (3) Evaluations of Coating Film

The gloss, the adhesion, the wear resistance, and the appearance of the coating film obtained were evaluated in the same manner as in Example 1. These results are shown in Table 1.

### (4) Evaluation for Leveling Property

The leveling property of the coating film obtained was evaluated in the same manner as in Example 1. The result is shown in Table 1.

### Example 7

### (1) Preparation of Floor Coating Material

A floor coating material according to Example 7 was prepared in the same manner as in Example 1, except the following: 20 mass % of a silane coupling agent (KBM 403, manufactured by Shin-Etsu Chemical Co., Ltd.) was used as the first component; 70 mass % of colloidal silica (40 mass % aqueous dispersion of silica (average particle size: 20 to 25 nm), manufactured by Nissan Chemical Corporation) (accordingly, the amount of silica was 28 mass %) was used as the second component;

and 50.495 mass % of water (including water contained in the colloidal silica) was used as the fifth component. The formulation thereof is shown in Table 1.

For the floor coating material according to Example 7, the total amount of the combustible products, the solid content, the flash point, and the burning point were each calculated in the same manner as in Example 1. These results are shown in Table 1.

### (2) Application to Flooring Material

A coating film was formed in the same manner as in Example 1, except that the floor coating material according to Example 7 was used.

### (3) Evaluations of Coating Film

The gloss, the adhesion, the wear resistance, and the appearance of the coating film obtained were evaluated in the same manner as in Example 1. These results are shown in Table 1.

### (4) Evaluation for Leveling Property

The leveling property of the coating film obtained was evaluated in the same manner as in Example 1. The result is shown in Table 1.

### Example 8

### (1) Preparation of Floor Coating Material

A floor coating material according to Example 8 was prepared in the same manner as in Example 1, except the following: 50 mass % of colloidal silica (40 mass % aqueous dispersion of silica (average particle size: 20 to 25 nm), manufactured by Nissan Chemical Corporation) (accordingly, the amount of silica was 20 mass %) was used as the second component; 3 mass % of phosphoric acid was used as the fourth component; and 46.995 mass % of water (including water contained in the colloidal silica) was used as the fifth component. The formulation thereof is shown in Table 1.

For the floor coating material according to Example 8, the total amount of the combustible products, the solid content, the flash point, and the burning point were each calculated in the same manner as in Example 1. These results are shown in Table 1.

### (2) Application to Flooring Material

A coating film was formed in the same manner as in Example 1, except that the floor coating material according to Example 8 was used.

### (3) Evaluations of Coating Film

The gloss, the adhesion, the wear resistance, and the appearance of the coating film obtained were evaluated in the same manner as in Example 1. These results are shown in Table 1.

### (4) Evaluation for Leveling Property

The leveling property of the coating film obtained was evaluated in the same manner as in Example 1. The result is shown in Table 1.

### Example 9

### (1) Preparation of Floor Coating Material

A floor coating material according to Example 9 was prepared in the same manner as in Example 8, except the following: 5 mass % of phosphoric acid was used as the fourth component; and 44.995 mass % of water (including water contained in the colloidal silica) was used as the fifth component. The formulation thereof is shown in Table 1.

For the floor coating material according to Example 9, the total amount of the combustible products, the solid content, the flash point, and the burning point were each calculated in the same manner as in Example 1. These results are shown in Table 1.

### (2) Application to Flooring Material

A coating film was formed in the same manner as in Example 1, except that the floor coating material according to Example 9 was used.

### (3) Evaluations of Coating Film

The gloss, the adhesion, the wear resistance, and the appearance of the coating film obtained were evaluated in the same manner as in Example 1. These results are shown in Table 1.

### (4) Evaluation for Leveling Property

The leveling property of the coating film obtained was evaluated in the same manner as in Example 1. The result is shown in Table 1.

### Example 10

### (1) Preparation of Floor Coating Material

A floor coating material according to Example 10 was prepared in the same manner as in Example 8, except the following: 0.1 mass % of a silicone compounds (BYK-349, manufactured by BYK Japan KK) was used as a third component; 1.5 mass % of phosphoric acid was used as the fourth component; and 48.4 mass % of water (including water contained in the colloidal silica) was used as the fifth component. The formulation is shown in Table 1.

For the floor coating material according to Example 10, the total amount of the combustible products, the solid content, the flash point, and the burning point were each calculated in the same manner as in Example 1. These results are shown in Table 1.

### (2) Application to Flooring Material

A coating film was formed in the same manner as in Example 1, except that the floor coating material according to Example 10 was used.

### (3) Evaluations of Coating Film

The gloss, the adhesion, the wear resistance, and the appearance of the coating film obtained were evaluated in the same manner as in Example 1. These results are shown in Table 1.

### (4) Evaluation for Leveling Property

The leveling property of the coating film obtained was evaluated in the same manner as in Example 1. The result is shown in Table 1.

### Example 11

### (1) Preparation of Floor Coating Material

A floor coating material according to Example 11 was prepared in the same manner as in Example 9, except the following: two types of silane coupling agents, specifically 30 mass % of a silane coupling agent (KBM 403, manufactured by Shin-Etsu Chemical Co., Ltd.) and 1 mass % of another silane coupling agent (KBM 903, manufactured by Shin-Etsu Chemical Co., Ltd.) were used as the first component; the fourth component was not used; and 48.995 mass % of water (including water contained in the colloidal silica) was used as the fifth component. The formulation thereof is shown in Table 1. The silane coupling agent (KBM 903, manufactured by Shin-Etsu Chemical Co., Ltd.) is a silane coupling agent having an amino group.

For the floor coating material according to Example 11, the total amount of the combustible products, the solid content, the flash point, and the burning point were each calculated in the same manner as in Example 1. These results are shown in Table 1.

### (2) Application to Flooring Material

A coating film was formed in the same manner as in Example 1, except that the floor coating material according to Example 11 was used.

### (3) Evaluations of Coating Film

The gloss, the adhesion, the wear resistance, and the appearance of the coating film obtained were evaluated in the same manner as in Example 1. These results are shown in Table 1.

### (4) Evaluation for Leveling Property

The leveling property of the coating film obtained was evaluated in the same manner as in Example 1. The result is shown in Table 1.

### Comparative Example 1

### (1) Preparation of Floor Coating Material

Sample 13 disclosed in Patent Literature 2 was used as a floor coating material according to Comparative Example 1. Sample 13 was obtained by mixing 45 mass % of an alkoxysilane (10 mass % of a difunctional alkoxysilane, 30 mass % of a trifunctional alkoxysilane, and 5 mass % of a tetrafunctional alkoxysilane), 30 mass % of colloidal silica having an average particle size of 5 to 20 nm (in an organic solvent), 2 mass % of a silane coupling agent, and 3 mass % of phosphoric acid as a catalyst. The formulation thereof is shown in Table 1.

As shown in Table 1, the total amount of the combustible products contained in the floor coating material according to Comparative Example 1 is more than 40%, and therefore the floor coating material falls within hazardous materials according to Fire Service Act.

### Comparative Example 2

### (1) Preparation of Floor Coating Material

The top coat composition described in Examples in Patent Literature 1 was used as a floor coating material according to Comparative Example 2. The top coat composition was obtained by mixing 16.7 mass % of a hybrid composition (HB21BN (solid content 27%), manufactured by Nitto Boseki Co., Ltd.), 5.0 mass % of an alkali soluble resin (SMA2625 (10% solution in solfit), manufactured by SARTOMER), 30.0 mass % of 3-methoxy-3-methyl-1-butanol (Solfit, manufactured by KURARAY CO., LTD.), 48.1 mass % of isopropyl alcohol, and 0.2 mass % of a modified silicone (BYK-302, manufactured by BYK Japan KK). The formulation thereof is shown in Table 1.

As shown in Table 1, the total amount of the combustible products contained in the floor coating material according to Comparative Example 2 is more than 40%, and therefore the floor coating material falls within hazardous materials according to Fire Service Act.

### Comparative Example 3

### (1) Preparation of Floor Coating Material

With reference to Example 1 in Patent Literature 3, 72 g of an acrylic resin solution, 48 g of composition (1), and 36 g of titanium oxide were mixed to prepare a floor coating material according to Comparative Example 3. The formulation thereof is shown in Table 1. Composition (1) was a composition obtained in the following manner: methanol, 0.1 N hydrochloric acid, a tetramethoxysilane oligomer, and water were added to a silane coupling agent to cause hydrolysis/condensation, and then, methyl isobutyl ketone was added thereto, followed by solvent removal, to thereby obtain a composition of interest.

As shown in Table 1, the total amount of the combustible products contained in the floor coating material according to Comparative Example 3 is more than 40%, and therefore the floor coating material falls within hazardous materials according to Fire Service Act.

### Comparative Example 4

### (1) Preparation of Floor Coating Material

A floor coating material according to Comparative Example 4 was prepared in the same manner as in Example 1, except the following: 75 mass % of a silane coupling agent (KBM 403, manufactured by Shin-Etsu Chemical Co., Ltd.) was used as the first component; 20 mass % of colloidal silica (40 mass % aqueous dispersion of silica (average particle size: 20 to 25 nm), manufactured by Nissan Chemical Corporation) (accordingly, the amount of silica was 8 mass %) was used as the second component; and 15.495 mass % of water (including water contained in the colloidal silica) was used as the fifth component. The formulation thereof is shown in Table 1.

As shown in Table 1, the total amount of the combustible products contained in the floor coating material according to Comparative Example 4 is more than 40%, and therefore the floor coating material falls within hazardous materials according to Fire Service Act.

### (2) Application to Flooring Material

A coating film was formed in the same manner as in Example 1, except that the floor coating material according to Comparative Example 4 was used.

### (3) Evaluations of Coating Film

The gloss, the adhesion, the wear resistance, and the appearance of the coating film obtained were evaluated in the same manner as in Example 1. These results are shown in Table 1.

### (4) Evaluation for Leveling Property

The leveling property of the coating film obtained was evaluated in the same manner as in Example 1. The result is shown in Table 1.

### Comparative Example 5

### (1) Preparation of Floor Coating Material

A floor coating material according to Comparative Example 5 was prepared in the same manner as in Comparative Example 4, except the following: 3 mass % of a silane coupling agent (KBM 403, manufactured by Shin-Etsu Chemical Co., Ltd.) was used as the first component; 0.3 mass % of phosphoric acid was used as the fourth component; and 88.695 mass % of water (including water contained in the colloidal silica) was used as the fifth component. The formulation thereof is shown in Table 1.

For the floor coating material according to Comparative Example 5, the total amount of the combustible products and the solid content were each calculated in the same manner as in Example 1. These results are shown in Table 1.

### (2) Application to Flooring Material

A coating material was applied in the same manner as in Example 1, except that the floor coating material according to Comparative Example 5 was used; however, a coating film was not successfully formed. This is probably because the content of silane coupling agent less than 5 mass % results in insufficient film-formability.

### Comparative Example 6

### (1) Preparation of Floor Coating Material

A floor coating material according to Comparative Example 6 was prepared in the same manner as in Example 1, except the following: 3 mass % of a silane coupling agent (KBM 403, manufactured by Shin-Etsu Chemical Co., Ltd.) was used as the first component; 55 mass % of fumed silica was used as the second component; and 40.495 mass % of water was used as the fifth component. The formulation thereof is shown in Table 1.

For the floor coating material according to Comparative Example 6, the total amount of the combustible products and the solid content were each calculated in the same manner as in Example 1. These results are shown in Table 1.

In the floor coating material according to Comparative Example 6, the contents of components other than the second component were small and out of balance to cause gelation, thereby failing to prepare a floor coating material.

### Comparative Example 7

### (1) Preparation of Floor Coating Material

A floor coating material according to Comparative Example 7 was prepared in the same manner as in Example 1, except the following: 30 mass % of colloidal silica (40 mass % aqueous dispersion of silica (average particle size: 20 to 25 nm), manufactured by Nissan Chemical Corporation) (accordingly, the amount of silica was 12 mass %) was used as the second component; 0.1 mass % of phosphoric acid was used as the fourth component; and 57.895 mass % of water (including water contained in the colloidal silica) was used as the fifth component. The formulation thereof is shown in Table 1.

For the floor coating material according to Comparative Example 7, the total amount of the combustible products and the solid content were each calculated in the same manner as in Example 1. These results are shown in Table 1.

### (2) Application to Flooring Material

A floor coating material was applied in the same manner as in Example 1, except that the floor coating material according to Comparative Example 7 was used; however, a coating film was not successfully formed. This is probably because curing of the film through the condensation reaction was insufficient due to the small content of phosphoric acid serving as a catalyst.

### Comparative Example 8

### (1) Preparation of Floor Coating Material

A floor coating material according to Comparative Example 8 was prepared in the same manner as in Comparative Example 7, except the following: 10.5 mass % of phosphoric acid was used as the fourth component; and 47.495 mass % of water (including water contained in the colloidal silica) was used as the fifth component. The formulation thereof is shown in Table 1.

For the floor coating material according to Comparative Example 8, the total amount of the combustible products, the solid content, the flash point, and the burning point were each calculated in the same manner as in Example 1. These results are shown in Table 1.

### (2) Application to Flooring Material

A coating film was formed in the same manner as in Example 1, except that the floor coating material according to Comparative Example 8 was used.

### (3) Evaluations of Coating Film

The gloss, the adhesion, the wear resistance, and the appearance of the coating film obtained were evaluated in the same manner as in Example 1. These results are shown in Table 1.

The floor coating material according to Comparative Example 8 provided a gloss as high as 83%, but it was poor in wear resistance and adhesiveness and also resulted in some repellence. This is probably because the condensation reaction proceeded excessively due to the large amount of the catalyst so that sufficient film strength was unlikely to be obtained, and also because the self-smoothing property was lost due to the high viscosity of the coating material.

### (4) Evaluation for Leveling Property

The leveling property of the coating film obtained was evaluated in the same manner as in Example 1. The result is shown in Table 1.

### Comparative Example 9

### (1) Preparation of Floor Coating Material

A floor coating material according to Comparative Example 9 was prepared in the same manner as in Comparative Example 7, except the following: the third component was not used; 1.5 mass % of phosphoric acid was used as the fourth component; and 56.5 mass % of water (including water contained in the colloidal silica) was used as the fifth component. The formulation thereof is shown in Table 1.

For the floor coating material according to Comparative Example 9, the total amount of the combustible products and the solid content were each calculated in the same manner as in Example 1. These results are shown in Table 1.

### (2) Application to Flooring Material

A floor coating material was applied in the same manner as in Example 1, except that the floor coating material according to Comparative Example 9 was used; however, a coating film was not successfully formed and was discontinuous. The reason for this is probably as follows: a fluorosurfactant as the third component serving as a leveling agent was not used, so that repellence was caused due to the difference in the surface tension between the surface coated and the coating material.

### Comparative Example 10

### (1) Preparation of Floor Coating Material

A floor coating material according to Comparative Example 10 was prepared in the same manner as in Comparative Example 7, except the following: 1.5 mass % of a silicone compounds (BYK-349, manufactured by BYK Japan KK) was used as the third component; 1.5 mass % of phosphoric acid was used as the fourth component; and 55 mass % of water (including water contained in the colloidal silica) was used as the fifth component. The formulation thereof is shown in Table 1.

For the floor coating material according to Comparative Example 10, the total amount of the combustible products and the solid content were each calculated in the same manner as in Example 1. These results are shown in Table 1.

### (2) Application to Flooring Material

A floor coating material was applied in the same manner as in Example 1, except that the floor coating material according to Comparative Example 10 was used; however, a coating film was not successfully formed. This is probably because the content of the silicone compound used as the third component serving as a leveling agent was so large that bleeding and tackiness were caused. In addition, much foam was generated upon coating, and the spreadability was also poor.

TABLE 1

| | Example | Example | Example | Example | Example | Example | Example | Example | Example | Example | Example |
|---|---|---|---|---|---|---|---|---|---|---|---|
| | 1 | 2 | 3 | 4 | 5 | 6 | 7 | 8 | 9 | 10 | 11 |
| First component: alkoxysilane | | 10 | | | | | | | | | |
| First component: epoxy silane | 30 | 20 | 30 | 10 | 30 | 39 | 20 | 30 | 30 | 30 | 30 |
| coupling agent | | | | | | | | | | | |
| First component: amino silane | | | | | | | | | | | 1 |
| coupling agent | | | | | | | | | | | |
| Composition (1) *1 | | | | | | | | | | | |
| First component: silica A *2 | 1 | 20 | 12 | 12 | 12 | 12 | 28 | 20 | 20 | 20 | 20 |
| Second component: silica B *2 | | | | | | | | | | | |
| Second component: fumed silica | | | | | | | | | | | |
| Titanium oxide | | | | | | | | | | | |
| Fourth component: phosphoric | 1.5 | 1.5 | 0.5 | 1.5 | 1.5 | 1.5 | 1.5 | 3 | 5 | 1.5 | 0 |
| acid (in terms of pure substance) | | | | | | | | | | | |
| Third component: | 0.005 | 0.005 | 0.005 | 0.005 | 0.005 | 0.005 | 0.005 | 0.005 | 0.005 | | 0.005 |
| fluorosurfactant | | | | | | | | | | | |
| (in terms of pure substance) | | | | | | | | | | | |
| Third component: silicone | | | | | | | | | | 0.1 | |
| compound | | | | | | | | | | | |
| Acrylic resin solution *3 | | | | | | | | | | | |
| HB21BN | | | | | | | | | | | |
| Solution of alkali soluble resin | | | | | | | | | | | |
| SQLFIT | | | | | | | | | | | |
| Isopropanol | | | | | | | | | | | |
| Modified silicone | | | | | | | | | | | |
| Fifth component: water | 67.495 | 48.495 | 57.495 | 76.495 | 56.495 | 47.495 | 50.495 | 46.995 | 44.995 | 48.4 | 48.995 |
| Total | 100 | 100 | 100 | 100 | 100 | 100 | 100 | 100 | 100 | 100 | 100 |
| Total amount of combustible | ≤40% | ≤40% | ≤40% | ≤40% | ≤40% | ≤40% | ≤40% | ≤40% | ≤40% | ≤40% | ≤40% |
| products | | | | | | | | | | | |
| Solid content | ≥10% | ≥10% | ≥10% | ≥10% | ≥10% | ≥10% | ≥10% | ≥10% | ≥10% | ≥10% | ≥10% |
| Flash point | 42° C. | 40° C. | 42° C. | 42° C. | 42° C. | 42° C. | 42° C. | 42° C. | 42° C. | 42° C. | 42° C. |
| Burning point | ≥60° C. | ≥60° C. | ≥60° C. | ≥60° C. | ≥60° C. | ≥60° C. | ≥60° C. | ≥60° C. | ≥60° C. | ≥60° C. | ≥60° C. |
| Categories of hazardous | no | no | no | no | no | no | no | no | no | no | no |
| materials according to Fire | | | | | | | | | | | |
| Service Act | | | | | | | | | | | |
| Gloss (%) | 85 | 84 | 85 | 85 | 86 | 86 | 85 | 85 | 85 | 81 | 66 |
| Appearance evaluation of gloss | ⊚ | ⊚ | ⊚ | ⊚ | ⊚ | ⊚ | ⊚ | ⊚ | ⊚ | ⊚ | ◯ |
| Leveling property | ⊚ | ⊚ | ⊚ | ⊚ | ⊚ | ⊚ | ⊚ | ⊚ | ⊚ | ⊚ | ◯ |
| Adhesion | Class 0 | Class 0 | Class 0 | Class 0 | Class 0 | Class 0 | Class 0 | Class 0 | Class 0 | Class 0 | Class 0 |
| Wear resistance (upper: gloss | 74 | 82 | 72 | 79 | 81 | 81 | 84 | 82 | 72 | 82 | 62 |
| (%), lower: evaluation) | ◯ | ⊚ | ◯ | ◯ | ⊚ | ⊚ | ⊚ | ⊚ | ◯ | ⊚ | ⊚ |
| | | Comparative | Comparative | Comparative | Comparative | Comparative | Comparative | Comparative | Comparative | Comparative | Comparative |
| | | Example | Example | Example | Example | Example | Example | Example | Example | Example | Example |
| | | 1 (*4) | 2 | 3 | 4 | 5 | 6 | 7 | 8 | 9 | 10 |
| | First component: alkoxysilane | 45 | | | | | | | | | |
| | First component: epoxy silane | 2 | | | 75 | 3 | 3 | 30 | 30 | 30 | 30 |
| | coupling agent | | | | | | | | | | |
| | First component: amino silane | | | | | | | | | | |
| | coupling agent | | | | | | | | | | |
| | Composition (1) *1 | | | 48 | | | | | | | |
| | First component: silica A *2 | | | | 8 | 8 | | 12 | 12 | 12 | 12 |
| | Second component: silica B *2 | 6-15 | | | | | | | | | |
| | Second component: fumed silica | | | | | | 55 | | | | |
| | Titanium oxide | | | 36 | | | | | | | |
| | Fourth component: phosphoric | 3 | | | 1.5 | 0.3 | 1.5 | 0.1 | 10.5 | 1.5 | 1.5 |
| | acid (in terms of pure substance) | | | | | | | | | | |
| | Third component: | | | | 0.005 | 0.005 | 0.005 | 0.005 | 0.005 | 0 | |
| | fluorosurfactant | | | | | | | | | | |
| | (in terms of pure substance) | | | | | | | | | | |
| | Third component: silicone | | | | | | | | | | 1.5 |
| | compound | | | | | | | | | | |
| | Acrylic resin solution *3 | | | 72 | | | | | | | |
| | HB21BN | | 16.7 | | | | | | | | |
| | Solution of alkali soluble resin | | 5 | | | | | | | | |
| | SQLFIT | | 30 | | | | | | | | |
| | Isopropanol | | 48.1 | | | | | | | | |
| | Modified silicone | | 0.2 | | | | | | | | |
| | Fifth component: water | | 0 | | 15.495 | 88.695 | 40.495 | 57.895 | 47.495 | 56.5 | 55 |
| | Total | | 100 | 156 | 100 | 100 | 100 | 100 | 100 | 100 | 100 |
| | Total amount of combustible | >40% | >40% | >40% | >40% | ≤40% | ≤40% | ≤40% | ≤40% | ≤40% | ≤40% |
| | products | | | | | | | | | | |
| | Solid content | ≥10% | unknown | ≥10% | ≥10% | ≥10% | ≥10% | ≥10% | ≥10% | ≥10% | ≥10% |
| | Flash point | | | | | | | | 42° C. | Not | Not |
| | | | | | | | | | | measured | measured |
| | Burning point | | | | | | | | ≥60° C. | Not | Not |
| | | | | | | | | | | measured | measured |
| | Categories of hazardous | yes | yes | yes | yes | failure in | failure in | failure in | no | no | no |
| | materials according to Fire | (Class II | (Class II | (Class II | (Class II | formation of | preparation | curing due | | | |
| | Service Act | petroleum) | petroleum) | petroleum) | petroleum) | film due to | (gelation) | to | | | |
| | Gloss (%) | | | | 86 | insufficiency | | insufficiency | 83 | n.d. | n.d. |
| | Appearance evaluation of gloss | | | | X | of first | | of fourth | X | n.d. | X (*6) |
| | Leveling property | | | | | component | | component | X | X (*5) | n.d. |
| | Adhesion | | | | Class 0 | | | and | Class 3 | n.d. | n.d. |
| | Wear resistance (upper: gloss | | | | 79 | | | therfore in | 43 | n.d. | n.d. |
| | (%), lower: evaluation) | | | | ◯ | | | formation of | X | n.d. | n.d. |
| | | | | | | | | film | | | |

*1 Composition obtained by adding methanol, 0.1 N-hydrochloric acid, a tetramethoxysilane oligomer, and water to a silane coupling agent to cause hydrolysis/condensation, adding methyl isobutyl ketone thereto, and removing the solvent
*2 Silica A was water-dispersible silica, and silica B was organic solvent-dispersible silica.
*3 obtained by adding isopropyl alcohol, methyl ethyl ketone, methyl methacrylate, ethyl acrylate, methacrylic acid, 2-hydroxyethyl acrylate, and 2,2′-azobisisobutyronitrile, and stirring the resultant under heating
*4 For Comparative Example 1, the formulation of sample No. 13 in Table 1 in JP4957926B was used.
*5 Other properties were not able to be determined because of failure in formation of a continuous film.
*6 Other properties were not able to be determined because of heavy bleeding.

1. A floor coating material comprising:
one or both of a silane coupling agent and an alkoxysilane, as a first component;
one or both of silica and a metal oxide, as a second component;
one or both of a silicone compound and a fluorosurfactant, as a third component;
a curing catalyst as a fourth component; and
water as a fifth component;
wherein
a content of the first component is 5 mass % or more and 70 mass % or less,
a content of the second component is 1 mass % or more and 50 mass % or less,
a content of the third component is 0.001 mass % or more and 1 mass % or less,
a content of the fourth component is 0.15 mass % or more and 7 mass % or less, and
a content of the fifth component is a balance, all based on the total mass of the first to fifth components, and
a total mass content of the first to fifth components is 95 mass % or more and 100 mass % or less based on the total mass of the floor coating material.

2. The floor coating material according to claim 1, wherein the first component comprises one or more selected from a silane coupling agent having an epoxy group, a silane coupling agent having an amino group, and an alkoxysilane oligomer; and
a total content of the first component, the third component and components other than the first to fifth components is less than 40 mass % based on the total mass of the floor coating material.

3. The floor coating material according to claim 1, wherein the silane coupling agent as the first component is a silane coupling agent having an epoxy group; and
the curing catalyst as the fourth component is phosphoric acid.

4. (canceled)

5. (canceled)

6. (canceled)

7. A floor coating material comprising:
a silane coupling agent or a silane coupling agent plus an alkoxysilane, as a first component, wherein the silane coupling agent comprises a silane coupling agent having an amino group;
one or both of silica and a metal oxide, as a second component;
one or both of a silicone compound and a fluorosurfactant, as a third component;
a curing catalyst as a fourth component; and
water as a fifth component;
wherein
a content of the first component is 5 mass % or more and 70 mass % or less,
a content of the second component is 1 mass % or more and 50 mass % or less,
a content of the third component is 0.001 mass % or more and 1 mass % or less,
a content of the fourth component is 0 mass % or more and 7 mass % or less, and
a content of the fifth component is a balance, all based on the total mass of the first to fifth components, and
a total mass content of the first to fifth components is 95 mass % or more and 100 mass % or less based on the total mass of the floor coating material.

8. The floor coating material according to claim 7, wherein a total content of the first component, the third component and components other than the first to fifth components is less than 40 mass % based on the total mass of the floor coating material.

9. A method for coating a floor, comprising a coating material-applying step of applying a floor coating material to a surface to be coated, wherein the floor coating material used in the coating material-applying step is the floor coating material according to claim 1.

10. A method for producing a floor structure, comprising a coating material-applying step of applying a floor coating material to a surface to be coated, wherein the floor coating material used in the coating material-applying step is the floor coating material according to claim 1.
